(19) United States
(12) Patent Application Publication
(10) Pub. No.: US 2002/0107703 A1
(43) Pub. Date: Aug. 8, 2002

(54) METHOD AND SYSTEM FOR AUTOMATED LIEN MANAGEMENT

(76) Inventors: PAUL FEINBERG, PHOENIX, AZ (US); PACIFIC TECHNOLOGIES GROUP, INC., PHOENIX, AZ (US)

Correspondence Address: Meschkow & Gresham, P.L.C., Jordan M. Meschkow, 5727 North Seventh Street, Suite 409, Phoenix, AZ, 85014, US

(21) Appl. No.: 09/360,478

(22) Filed: Jul. 16, 1999

(51) Int. Cl. G06F 17/60

(52) U.S. Cl. 705/2; 705/35

(57) ABSTRACT

A method and system for automating the preparation, recordation, tracking and filing of liens, assignments, and other legal documents relating to securing payment of a debt or other obligation or transfer of ownership of an asset. Certain lien information is provided by a lien holder to a centralized database via the Internet. The data is validated for proper content and format according to the appropriate government recording agency's guidelines. A lien document is prepared from the validated information for transmittal to the recording agency, including a notarized signature of an authorized agent. For agencies that do not accept electronic filing, a paper copy of the legal instrument printed. The document is then submitted to the recording agency, either electronically for those agencies that accept electronic filing or manually for those agencies that do not. The lien document is updated with a recording number and a recording date. The liable party is served notice of the lien and the lien holder is notified of a perfected lien.

### BACKGROUND OF THE INVENTION

This invention relates generally to data processing, and more particularly to automatic preparation, recordation, tracking and filing of liens, assignments, and other legal documents relating to securing payment of a debt or other obligation or transfer of ownership of an asset. The security interest is perfected by recording appropriate documents with the appropriate government agency using the proper format and procedure, which differ from locale to locale depending on local laws and regulations. The process allows the beneficiaries to use the legal system to ensure satisfaction of the obligation. Automated management of the preparation, recordation, tracking and filing of such documents, referred to herein as liens, is desired.

Medical liens are—filed by healthcare providers such as physicians, hospitals, therapists, and medical equipment suppliers to obtain a security interest in the claims payments made to patients by insurance companies for the medical care provided. The process ensures that the patient or available insurance coverage pay the service or equipment provider its share of the reimbursement, once the insurance company settles or disburses finds related to the liability claim which caused the patient's injuries. The volume and complexity of patient and insurance transactions, in combination with multiple data variables, makes preparation of liens difficult, costly and time consuming. Consequently, it is desirable to automate a process for their creation, administration and release.

Currently healthcare liens are prepared manually by each healthcare provider or are outsourced to a variety of financial service bureaus or law firms. The legal instruments are prepared with certain information required by law or rule, often on a specialized form. This information includes the patient's name and contact information and the patient's insurer and policy information. Personal injury information is required regarding the circumstances surrounding the accident, such as the type and location of the accident, the patient's attorney, if represented, and the liable party's insurance information. The required information or form may differ from jurisdiction to jurisdiction. If the information provided is incomplete or formatted incorrectly, the lien might not be perfected.

Once the information is in a proper format, the lien must be submitted according to proper procedural guidelines, which also differ from jurisdiction to jurisdiction. The lien must be filed with the proper government office, usually within a specified time from date of first treatment. Certain parties need to be notified by a designated method of service that a lien has been recorded, depending on the type of insurance involved, such as public insurance (government assistance), private insurance, or workman's compensation. The lien procedure is also affected by the type of insurance schemas under which the state operates, such as fault and no fault insurance schemas, as well as whether the jurisdiction has a healthcare lien statute that incorporates the private sector. Once the lien documents are properly prepared and subsequently accepted by the government, the recording agency records the lien and provides a recording number. The lien documents are then archived and stored for the submitter. It is necessary to serve notice on the patient and all responsible insurance companies or parties that a lien on the expected payment has been recorded.

Once the service provider receives payment, it is necessary to file a satisfaction or release of the lien A release or satisfaction is prepared with the recording number and other certain information required by law or rule, again often on a specialized form which may differ from jurisdiction to jurisdiction. The release is submitted to the proper agency and recorded.

It is an object of this invention to provide an automated system for preparing, recording, tracking and filing liens, assignments, and other documents perfecting security interests. It is another object of this invention to provide a single lien management system which can handle all regulatory schemas. It is a further object of this invention to provide a lien management system which operates on a computer network to accommodate multiple clients, recording agencies, and changing recording guidelines. It is another object of this invention to provide an automated system for filing medical liens and assignments on behalf of medical service and medical equipment providers.

### BRIEF SUMMARY OF THE INVENTION

The present invention provides a method and system for automating the preparation, recordation, tracking and filing of liens, assignments, and other legal documents relating to securing payment of a debt or other obligation or transfer of ownership of an asset. Certain lien information is provided by a lien holder to a centralized database via the Internet. The data is validated for proper content and format according to the appropriate government recording agency's guidelines. A lien document is prepared from the validated information for transmittal to the recording agency, including a notarized signature of an authorized agent. For agencies that do not accept electronic filing, a paper copy of the legal instrument printed. The document is then submitted to the recording agency, either electronically for those agencies that accept electronic filing or manually for those agencies that do not. The lien document is updated with a recording number and a recording date. The liable party is served notice of the lien and the lien holder is notified of a perfected lien.

### BRIEF DESCRIPTION OF THE DRAWINGS

FIG. 1 depicts the flow of information for a lien filing using a data processing system according to the present invention.

FIG. 2 is a flow chart of the lien filing of the present invention.

FIG. 3 is a flow chart of the release of a lien of the present invention.

### DESCRIPTION OF THE PREFERRED EMBODIMENTS

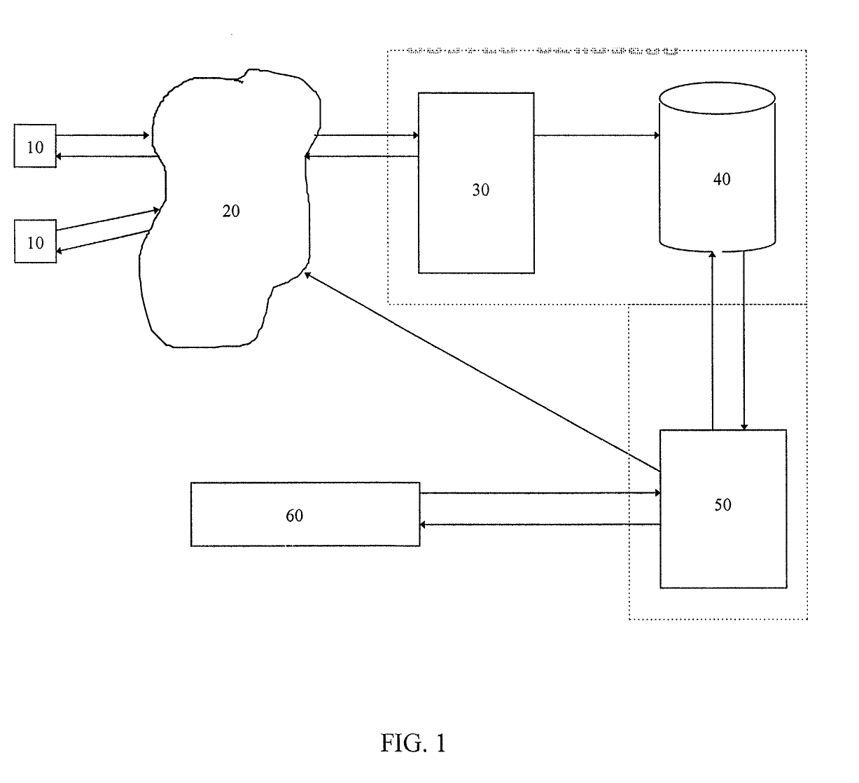

This invention is best understood by reading the following description in conjunction with reference to the accompanying FIGS. 1-3. FIG. 1 depicts the flow of information on a computer system according to the present invention. The preferred embodiment of the invention will be shown and described in application to a health care provider lien, which is referred to throughout the description as a medical lien. Preferably a plurality of clients 10 on remote nodes are temporarily and intermittently linked to the data-processing server 30, for example, by the Internet 20. In the preferred embodiment for medical lien filing, the client 10 is a medical service provider such as a physician, hospital, or therapist. The medical service provider authorizes an agent to prepare and file liens and assignments on its behalf, for a fee. The agent centralizes the reception and storage of information, preparation of documents, and their submission, as indicated by the dashed line of FIG. 1. The system may be integrated into one computer, or distributed across several computers and computer networks. The client 10 prepares an electronic data file of information including the patient's identification, patient's insurance information, the liable party's identification and the liable party's insurance information. The patient's identification includes at least the patient's name and address. The insurance information includes at least the liable party's insurance carrier's name, address and claim number under which the insured is covered. Additional information may be required, such as the type and location of the accident and the patient's attorney, if represented.

The data is transmitted from the client 10 via the Internet 20 to the data processing server 30. The data is transmitted using email communication protocols, and may also be transmitted using web based protocols in essentially a batch transfer mode, as is known in the art. Preferably each client 10 has its own mailbox dedicated to data transfer. Alternate connections may be used instead of an email mailbox, such as a web portal. The server 30 receives the transmission into the mailbox in the preferred embodiment. Alternatively, the data can be transmitted directly to the server 30 from an on-line Internet account through a portal dedicated to receipt of data. The data may be encrypted for improved security. The data is extracted from the message stream and stored on a storage means, represented in FIG. 1 as a database 40, as is known in the art. The database is managed by a software program, as is known in the art, such as SQL Server®, sold commercially by Microsoft, Inc. The server 30 validates the data by comparing it to a set of guidelines, which have previously been stored on the database 40. The guidelines set forth the content and format of the information required to properly file a lien in each given jurisdiction. The guidelines are compiled from statutes, regulations, and local practice for each locale. If comparison shows that the data fits the appropriate guidelines, the server 30 returns an acknowledgment to the client 10 via the Internet 20. If the comparison shows that the data does not fit the appropriate guidelines, the server 30 returns a negative acknowledgment to the client 10 via the Internet 20. The client then edits the data to comply with the guidelines and resends the data to the server 30. Validated data is stored in the database 40.

A medical lien is then created by a separate software program 50 from the data on the database 40. Such software program is used internally by Pacific Technologies Group, Inc., known as the Secure™ Corporate. The content and format of the document are specified by the guidelines stored in the database 40. The document is signed and notarized electronically via the software program 50, under prior authorization to sign the document on behalf of the medical service provider. The authorized signature is generated and notarized by computer so that manual signatures are not required. An electronic notary log is maintained. This step enables the system to handle a significantly larger volume of legal instruments than would be feasible if each document had to be signed or notarized by hand. The lien is transmitted in electronic form to the appropriate recording agency 60, unless the agency does not accept electronic filing. In such case, the document is printed on paper and manually delivered to the recording agency. The recording agency 60 reviews the document for proper format and content. If acceptable, the recording agency records the medical lien, giving it a recording number and a recording date. The recording number and recording date are input into the software program 50, which forwards the information to the database 40 to update the associated records.

The patient is notified of the outstanding lien by the notification method specified by jurisdiction, typically by certified U.S. mail. Blocks of certified mail numbers are obtained from the United States Post Office and previously stored in the database 40. Each recorded medical lien is assigned a certified mail number and a copy of the document is sent to the patient by certified mail with this number. The associated records in the database 40 are updated with the certified mail number. Finally, an electronic message is transmitted via the Internet 20 by the software program 50 to the client's dedicated email mailbox to notify the client that the lien has been recorded and served on the liable party's insurance carriers and the patient. The notification includes the recording number, recording date, certified mail number and legal description of the instrument.

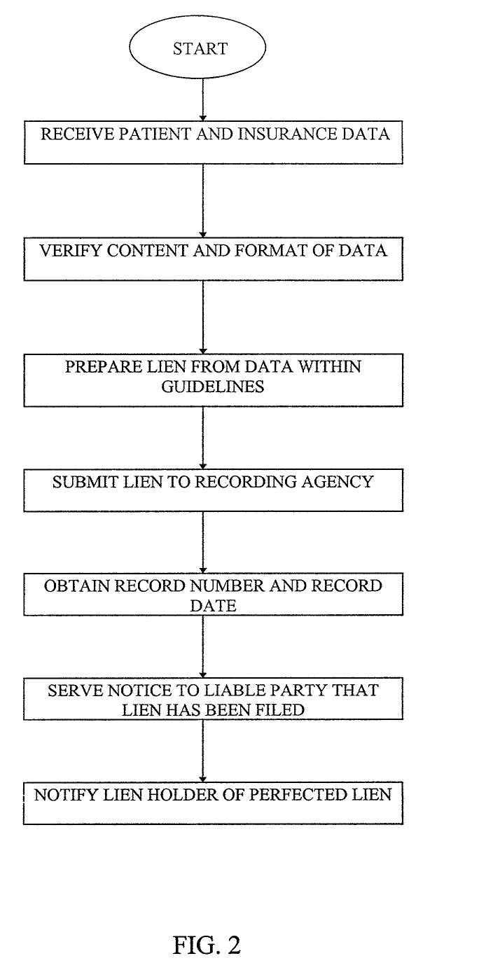

FIG. 2 shows the process steps of the lien filing system. Patient and insurance data is received from a remote node and stored in the database. The content and format of the data is verified. If the format and content meet guidelines set forth by the corresponding recording agency where the medical lien is to be filed, a document is prepared according to the guidelines and submitted to the recording agency. The recording agency supplies a recording number and recording date, which are documented on the document. A copy of the document is sent to the liable party, typically the patient's insurance carrier, and to the liable party's insurance carrier to give notice of the liability. Reimbursements from the insurance company are used to satisfy the debt of the patient to the medical service provider. Similarly, the lien holder is notified that the claim has been perfected.

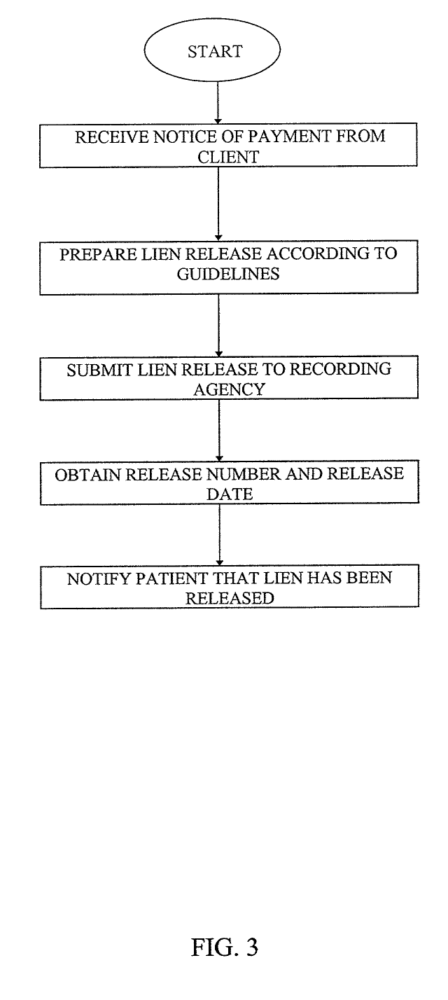

Once the lien holder has been paid, a release or satisfaction is filed to indicate the debt has been paid. The process for releasing the lien is similar to filing a lien. FIG. 3 shows the process steps of the release system. Viewed in conjunction with FIG. 1, in the preferred embodiment the client 10 transmits an e-mail message to the data processing server 30 via the Internet 20 giving notice that the client has received proper payment for a given patient's services. Alternatively the message may be transmitted using web based protocols in essentially a batch transfer mode. A release is prepared by the software program 50 from the patient and insurance data previously transmitted and stored in the database 40 when the lien was originally prepared. The release is prepared according to guidelines from each jurisdiction previously stored on the database 40. The release is transmitted in electronic form to the appropriate recording agency 60, unless the agency does not accept electronic filing. In such case, the release is printed on paper and manually delivered to the recording agency. The recording agency records the release. A copy of the release is archived and may be sent to the liable party and patient. The software program 50 is current with the release information.

The present invention can be applied to other types of liens, for example for financing or payments related to commercial and residential construction, referred to herein as construction liens. In a second embodiment of the invention, an electronic data file is prepared containing information relating to the construction lien holder's interest in the structure which the lien holder built, altered or repaired. The required information includes at least the name and address of the property owner and the legal description of the lands and improvements to be charged with the construction lien. The construction lien information is provided by the builder, contractor equipment, materials or labor supplier to a centralized database via the Internet and it is validated for proper content and format according to the appropriate government recording agency's guidelines. A construction lien is prepared from the validated information for transmittal to the recording agency, including a notarized signature of the authorized agent. For agencies that do not accept electronic filing, a paper copy of the construction lien is printed. The document is then submitted to the recording agency, either electronically for those agencies that accept electronic filing or manually for those agencies that do not. The document is updated with a recording number and a recording date. The liable party is served notice of the construction lien and the lien holder is notified of a perfected construction lien.

Numerous types of liens and assignments exist, whether statutory or contractual, in the various jurisdictions. The invention is applicable to the preparation, recordation, tracking and filing of many types of liens, assignments, stop notices and other legal documents relating to securing payment of a debt or other obligation or transfer of ownership of an asset. For example, the application of this invention to healthcare provider liens is described in the preferred embodiment above, and the application of this invention to construction liens is described in the second embodiment above. Although not specifically described herein, the invention is also applicable to agricultural liens, judgment liens, personal property liens, tax liens, innskeepers' liens, farm services lien, mechanics' or materialmen's liens, and all other legal documents relating to securing payment of a debt or other obligation or transfer of ownership of an asset.

The objects of this invention are achieved through the aforementioned improvements. It will be understood that various modifications may be made to the system and the method of using it without departing from the purview of the appended claims. Although certain preferred embodiments have been shown and described, it should be understood that other embodiments and modifications that achieve these objects may be apparent to those of skill in the art and are within the scope of the appended claims.

I claim:

1. An automated method for preparing, recording, tracking and filing a lien with an appropriate governmental agency using a computer system consisting of a plurality of remote nodes which are temporarily and intermittently linked to a data processing server, the method comprising the steps of:
a) receiving data including a lien holder's identification and a liable party's identification from a remote node;
b) verifying that the content and format of the data meet a plurality of guidelines set forth by the appropriate government agency which have been previously stored on the database and, if the content and format are verified, storing the data in the database;
c) preparing the lien using the data and the plurality of guidelines;
e) submitting the lien to the appropriate recording agency;
f) obtaining a recording number and a recording date;
g) storing the recording number and the recording date on the database in association with the liable party's identification;
h) serving the liable party notice that the lien has been recorded and updating the database that the liable party has been served;
i) notifying the lien holder that the document has been recorded and that notice was served to the liable party, the notification including the recording number and recording date.

2. The method according to claim 1 wherein the lien further comprises an assignment.

3. An automated method for preparing, recording, tracking and filing a medical lien with an appropriate governmental agency using a computer system consisting of a plurality of remote nodes which are temporarily and intermittently linked to a data processing server, the method comprising the steps of:
a) receiving data including patient identification and a liable party's identification, insurance carrier, and a policy number from a remote node;
b) verifying that the content and format of the data meet a plurality of guidelines set forth by the appropriate government agency which have been previously stored on the database and, if the content and format are verified, storing the data in the database;
c) preparing the medical lien using the data and the plurality of guidelines;
e) submitting the lien to the appropriate recording agency;
f) obtaining a recording number and a recording date;
g) storing the recording number and the recording date on the database in association with the patient identification;
h) serving the liable party notice that the lien has been recorded and updating the database that the liable party has been served;
i) notifying the lien holder that the document has been recorded and that notice was served to the liable party, the notification including the recording number and recording date.

4. The method according to claim 3 further comprising the step of transmitting a message to the remote node that the content or format does not meet the guidelines, if the content and format are not verified.

5. The method according to claim 3 further comprising the step of notarizing the lien with a computerized signature, before the lien and the assignment are submitted to the recording agency.

6. The method according to claim 3 further comprising the step of printing the medical lien and submitting the paper copy, if the appropriate recording agency does not accept electronic filing or transmitting the medical lien electronically, if the appropriate recording agency accepts electronic filing.

7. The method according to claim 3 further comprising the steps to release a medical lien including:
a) receiving notice of payment data from a remote node;
b) storing the notice of payment data in the database;
c) preparing the release using the notice of payment data and the plurality of guidelines;
e) submitting the release to the appropriate recording agency;
i) notifying required parties that a release has been filed.

7. The method according to claim 2 wherein the medical lien further comprises an assignment.

8. A data processing system for preparing, recording, tracking and filing a lien with an appropriate recording agency using a computer system consisting of a plurality of remote nodes which are temporarily and intermittently linked to a data processing server, the system comprising:
a) a computer processor means for processing data;
b) storage means for storing data on a storage means;
c) a second means for receiving data including a lien holder's identification and a liable party's identification from a remote node;
d) a third means for verifying that the content and format of the data meet a plurality of guidelines set forth by the appropriate recording agency which have been previously stored on the storage means and, if the content and format are verified, storing the data on the storage means;
e) a fourth means for preparing the lien using the data and a subset of the plurality of guidelines;
f) a fifth means for submitting the lien to the appropriate recording agency;
g) a sixth means for obtaining a recording number and recording date and storing the recording number and recording data on the storage means in association with the patient identification;
h) a seventh means for serving a liable party notice that the lien has been recorded and updating the storage means that the liable party has been served;
i) an eighth means for notifying the lien holder that the document has been recorded and notice served to the liable party, the notification including the recording number and recording date.

9. A data processing system for preparing, recording, tracking and filing a medical lien with an appropriate recording agency using a computer system consisting of a plurality of remote nodes which are temporarily and intermittently linked to a data processing server, the system comprising:
a) a computer processor means for processing data;
b) storage means for storing data on a storage means;
c) a second means for receiving data including patient identification, a liable party's identification, insurance carrier, and a policy number received from a remote node;
d) a third means for verifying that the content and format of the data meet a plurality of guidelines set forth by the appropriate recording agency which have been previously stored on the storage means and, if the content and format are verified, storing the data on the storage means;
e) a fourth means for preparing the medical lien using the data and a subset of the plurality of guidelines;
f) a fifth means for submitting the medical lien to the appropriate recording agency;
g) a sixth means for obtaining a recording number and recording date and storing the recording number and recording data on the storage means in association with the patient identification;
h) a seventh means for serving a liable party notice that the medical lien has been recorded and updating the storage means that the liable party has been served;
i) an eighth means for notifying the medical lien holder that the document has been recorded and notice served to the liable party, the notification including the recording number and recording date.

10. The system according to claim 9 further comprising means for preparing a medical lien release using notice of payment data and the plurality of guidelines.

11. The system according to claim 9 wherein the medical lien further comprises an assignment.
